(19) United States
(12) Patent Application Publication
(10) Pub. No.: US 2022/0383265 A1
(43) Pub. Date: Dec. 1, 2022

(54) INTELLIGENT MEETING SCHEDULING ASSISTANT USING USER ACTIVITY ANALYSIS

(71) Applicant: Avaya Management L.P., Durham, NC (US)

(72) Inventors: Pragati Dhumal, Pune (IN); Tanvi Sharma, Pune (IN); Navanath Navaskar, Pune (IN)

(21) Appl. No.: 17/329,555

(22) Filed: May 25, 2021

(51) Int. Cl. G06Q 10/10; G06N 3/08

(52) U.S. Cl. CPC G06Q 10/1095; G06N 3/08; H04L 51/04

(57) ABSTRACT

A device may identify at least one user associated with a meeting invitation. The at least one user may be a meeting host, a meeting invitee, or both. The device may determine presence data associated with the at least one user. The device may provide at least a portion of the presence data to a machine learning network. The device may receive an output from the machine learning network in response to the machine learning network processing at least the portion of the presence data. The output may include a predicted availability of the at least one user for each candidate temporal period of a set of candidate temporal periods. The device may display one or more suggested temporal periods for the meeting invitation, from among the set of candidate temporal periods, based on the output from the machine learning network.

### FIELD

The present disclosure relates to systems and methods for meeting scheduling based on an analysis of activity patterns of participants.

### BACKGROUND

Some devices may support scheduling applications such as, for example, calendar applications. In some cases, a scheduling application may support meeting scheduling between a user and one or more invitees.

### BRIEF SUMMARY

The described techniques relate to improved methods, systems, devices, and apparatuses that support an artificial intelligence scheduling assistant. Generally, the described techniques provide for an intelligent meeting scheduling assistant that learns and suggests the active patterns associated with working hours of an invitee to achieve higher rates of meeting acceptances and meeting efficiencies.

A method, device, and system are provided that include: identifying at least one user associated with a meeting invitation; determining presence data associated with the at least one user; providing at least a portion of the presence data to a machine learning network; receiving an output from the machine learning network in response to the machine learning network processing at least the portion of the presence data; and displaying one or more suggested temporal periods for the meeting invitation, from among the set of candidate temporal periods, based on the output from the machine learning network.

In some aspects, the output may include a predicted availability of the at least one user for each candidate temporal period of a set of candidate temporal periods. The method may include selecting a temporal period from among the one or more suggested temporal periods, based on the output from the machine learning network; and transmitting the meeting invitation to a device associated with the at least one user based on the selecting. In an example, the meeting invitation may include an indication of the selected temporal period.

These and other needs are addressed by the various embodiments and configurations of the present disclosure. The present disclosure can provide a number of advantages depending on the particular configuration. These and other advantages will be apparent from the disclosure contained herein.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “analyze,” “process,” “execute,” “manage,” “calculate,” and “compute,” and variations thereof, as used herein, are used interchangeably and include any type of methodology, process, mathematical operation or technique. The term “manage” includes any one or more of the terms determine, recommend, configure, organize, show (e.g., display), hide, update, revise, edit, and delete, and includes other means of implementing actions (including variations thereof).

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 illustrates an example of a system that supports an intelligent meeting scheduling assistant using user activity analysis in accordance with aspects of the present disclosure.

FIG. 2 illustrates an example of a system that supports an intelligent meeting scheduling assistant using user activity analysis in accordance with aspects of the present disclosure.

FIG. 3 illustrates an example of a scheduling application that supports an intelligent meeting scheduling assistant using user activity analysis in accordance with aspects of the present disclosure.

FIG. 4 illustrates an example of a process flow that supports an intelligent meeting scheduling assistant using user activity analysis in accordance with aspects of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides illustrative embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the illustrative embodiments will provide those skilled in the art with an enabling description for implementing an illustrative embodiment. It should however be appreciated that the present disclosure may be practiced in a variety of ways beyond the specific detail set forth herein.

Some devices may support scheduling applications (also referred to herein as calendar applications or meeting scheduler applications) for scheduling meetings between a user and one or more invitees. In some cases, while scheduling a meeting, some scheduling applications may generally display the calendar availability of invitees to assist in the scheduling process. However, in some cases, although an invitee may be indicated as available for a time slot(s), the invitee may not have an active presence during said time slot(s).

For example, due to external factors (e.g., a difference in working hours or time zones) between the user and the invitee, an invitee may have a free time slot at the time proposed by the user, but may be out of office during said time. In some cases, the invitee may be inactive (e.g., online but away) at the time proposed by the user. Accordingly, the probability of the invitee accepting a meeting invitation (also referred to herein as a meeting request) may be low for a meeting scheduled in such a time slot.

Additionally, in some cases, an invitee may accept a meeting invitation as-is, even if the time slot associated with the meeting is during a non-preferred time period of the invitee (e.g., a time slot not suited for the invitee based on activity patterns). Such cases may result in an inefficient meeting, for example, due to external negative factors associated with the non-preferred time period (e.g., a lack of privacy for attending the meeting during the time period, unproductive working conditions during the time period, etc.). Accordingly, for example, the invitee may later decide to reschedule the meeting, which may result in additional communications and time spent by the user and the invitee in order to secure a meeting time (e.g., at a different time period) that is suitable for both the user and the invitee.

Some scheduling applications may support accessing the calendar availability of an invitee and dynamically scheduling a meeting based on free slots of invitees. However, such scheduling applications at most provide for identifying time slots for scheduling a meeting based on calendar availability, without considering or learning the activity patterns (also referred to herein as a working patterns) of the invitees when identifying an available time slot (e.g., an optimal time slot) for the user and the invitees.

In an example of some scheduling applications, a first user (e.g., John) may wish to set up a meeting with a second user (e.g., Mike) for project related discussions involving a high amount of attention and deep analysis. When scheduling the meeting, for example, the first user may see that the second user is available during an evening time slot between 6 pm and 8 pm. However, during 6 pm and 8 pm, the second user may be inactive or have low activity with respect to work related matters (e.g., be away from the computer) due to other activities having a relatively higher priority. In an example, the first user, being unaware this pattern, may propose a meeting during the evening time slot between 6 pm and 8 pm. Accordingly, for example, the second user may decline the proposed meeting, and additional communications back and forth between the first user and the second user may follow in order to secure a meeting time. In another example, the second user may accept the proposed meeting request as-is, even if inconvenient due to the proposed time, which may lead to a less productive and inefficient discussion.

According to example aspects of the present disclosure, a device supportive of an intelligent meeting scheduling assistant using user activity analysis is described herein. For example, machine learning techniques described herein may support automatically learning activity patterns (also referred to herein as a working patterns) of multiple users (e.g., one or more meeting hosts, one or more invitees). In some aspects, the machine learning techniques may support suggesting temporal periods (also referred to herein as meeting times, time slots, and/or time periods) for the users based on the learned activity patterns. For example, various artificial intelligence (AI) algorithms described herein may support the prediction of candidate temporal periods (e.g., candidate time slots, candidate meeting times) of high availability, medium availability, low availability, and/or no availability for users based on the learned activity patterns. In some aspects, a machine learning network may provide or output reports indicating patterns associated with the periods of high availability, medium availability, low availability, and/or no availability.

In some examples, based on outputs from the machine learning network, a device may provide the meeting host with suggested temporal periods (e.g., suggested meeting times, suggested time slots) based on the learned activity patterns. In some aspects, the device may provide analysis reports indicating temporal periods which may be optimal for scheduling a meeting with an invitee (e.g., have a higher probability of being accepted by an invitee, a higher probability of being convenient for the invitee, a higher probability for a productive and efficient discussion, etc.). In an example, the device may provide the analysis reports based on a predicted working pattern of the invitee in combination with a calendar availability of the invitee.

In some aspects, the device (e.g., machine learning network, scheduling application) may predict working patterns of invitees based on historical presence information (e.g., presence information associated with one or more prior temporal periods) associated with the invitees and different temporal periods. In an example, the device may obtain the presence information from one or more presence servers and/or presence applications. The presence information may indicate, for example, whether an invitee is available (e.g., logged in to a presence application associated with a presence server) or unavailable (e.g., logged off, logged in but in an “away” status, logged in but in a “do not disturb” status, logged in but in an “inactive” status). In some cases, the device may further analyze and predict working patterns of a meeting host based on historical presence information associated with the host and different time periods.

The predicted working patterns may include indications of active presence of an invitee (e.g., active working hours, a duration which an invitee remains active) and/or a meeting host with respect to one or more temporal periods. In some other examples, the predicted working patterns may include indications of intermittent active presence (e.g., active but is frequently away from the computer, active but relatively slow to respond to communications, etc.) of an invitee and/or a meeting host with respect to one or more temporal periods. In other examples, the predicted working pattern may include indications of an inactive presence (e.g., an “away” status, an “offline” status) of an invitee and/or a meeting host with respect to one or more temporal periods.

In some aspects, the device (e.g., using the machine learning network) may support intelligent meeting scheduling for multiple invitees. For example, using a scheduling application described herein, the device may provide analysis reports indicating optimal temporal periods for scheduling a meeting with multiple invitees (e.g., time slots having a relatively higher probability of being accepted by the invitees, a higher probability of being convenient for the invitees, a higher probability for a productive and efficient discussion, etc.). In some examples, the device may provide the analysis reports based on learned working patterns (e.g., predicted active presence, predicted intermittent active presence, predicted inactive presence, etc.) of the invitees in combination with calendar availabilities of the invitees. In some cases, the device may determine optimal temporal periods based on learned working patterns and calendar availabilities of both invitees and a meeting host.

In some example aspects, the device may support forward learning based on training data. For example, the device may support forward learning based on past actions (e.g., acceptances, rejections, alternative meeting time suggestions) of an invitee with respect to previous meeting invitations. Based on the forward learning, the device may provide increased accuracy when providing suggested temporal periods in an analysis report. In some aspects, the device may support forward learning based on past actions of an invitee (e.g., acceptances, rejections, alternative meeting time suggestions) in combination with past actions of a meeting host (e.g., acceptances, rejections, finalized meeting times, etc.). In some aspects, the device may support data models (e.g., neural network models) that are tunable according to user parameters, user configurations, and/or user preferences.

In some other aspects, the device (e.g., using the machine learning network) may support categorizations of suggested temporal periods for scheduling a meeting. For example, the device may provide (e.g., display) different temporal periods associated with scheduling a meeting with an invitee(s), in combination with respective categorizations (e.g., high availability, moderate availability, low availability, no availability) for the time slots. In some examples, the device may indicate the categorizations as scores or percentage values, based on which a meeting host may more accurately schedule a meeting time.

The example analysis reports and categorizations described herein may support increases in the quantity of accepted meeting requests, increased acceptance rates of meeting requests, increased convenience of meeting participants, and increased meeting efficiency and productivity.

Examples of the aspects described herein may provide advantages over other scheduling applications. For example, some scheduling applications may provide scheduling automation using a combination of predefined email scheduling templates, calendar availability analysis, and time zone matching. However, in scheduling meetings, such solutions may rely on manually entered user preferences with respect to time slot availability. In some cases, if no user preferences are available (e.g., no manually entered time slots are indicated or available), such scheduling applications may be unable to accurately predict the availability of an invitee, as only calendar availabilities of the invitee may be available.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

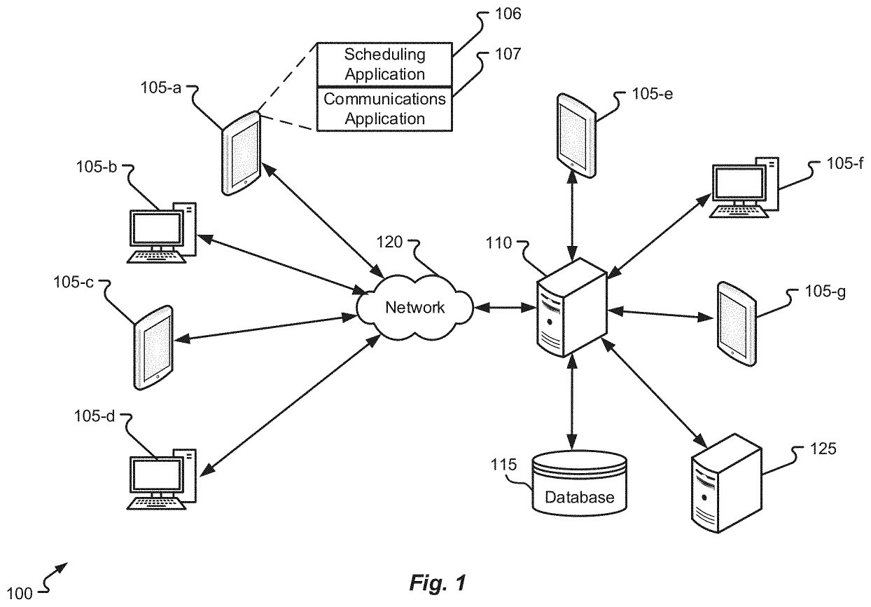

FIG. 1 illustrates an example of a system 100 that supports an intelligent meeting scheduling assistant using user activity analysis in accordance with aspects of the present disclosure.

The system 100 may include communication devices 105 (e.g., communication device 105-a through communication device 105-g), an application server 110, a database 115, a communication network 120, and a presence server 125. The communication network 120 may facilitate machine-to-machine communications between any of the communication device 105 (or multiple communication devices 105), the application server 110, the presence server 125, or one or more databases (e.g., database 115). The communication network 120 may include any type of known communication medium or collection of communication media and may use any type of protocols to transport data between endpoints. The communication network 120 may include wired communications technologies, wireless communications technologies, or any combination thereof.

A communication device 105 may transmit or receive data packets to one or more other devices (e.g., another communication device 105, the application server 110, the presence server 125) via the communication network 120 and/or via the application server 110. For example, the communication device 105-a may communicate (e.g., exchange data packets) with the communication device 105-b via the communications network 120. In another example, the communication device 105-a may communicate with another device (e.g., communication device 105-e, database 115) via the communications network 120 and the application server 110.

Non-limiting examples of the communication devices 105 may include, for example, personal computing devices or mobile computing devices (e.g., laptop computers, mobile phones, smart phones, smart devices, wearable devices, tablets, etc.). In some examples, the communication devices 105 may be operable by or carried by a human user. In some aspects, the communication devices 105 may perform one or more operations autonomously or in combination with an input by the user.

The communication devices 105 may support one or more scheduling applications 106 (e.g., calendar applications, meeting scheduler applications) for scheduling meetings between users of the communication devices 105. In some aspects, the communication devices 105 may support one or more communications applications 107 (also referred to herein as an integrated communications applications) for communication between the communication devices 105. The communications applications 106, for example, may support integrated audio, video, and text communications between communication devices 105. In some cases, the communications applications 107 may support instant messaging, availability services, and roster management services.

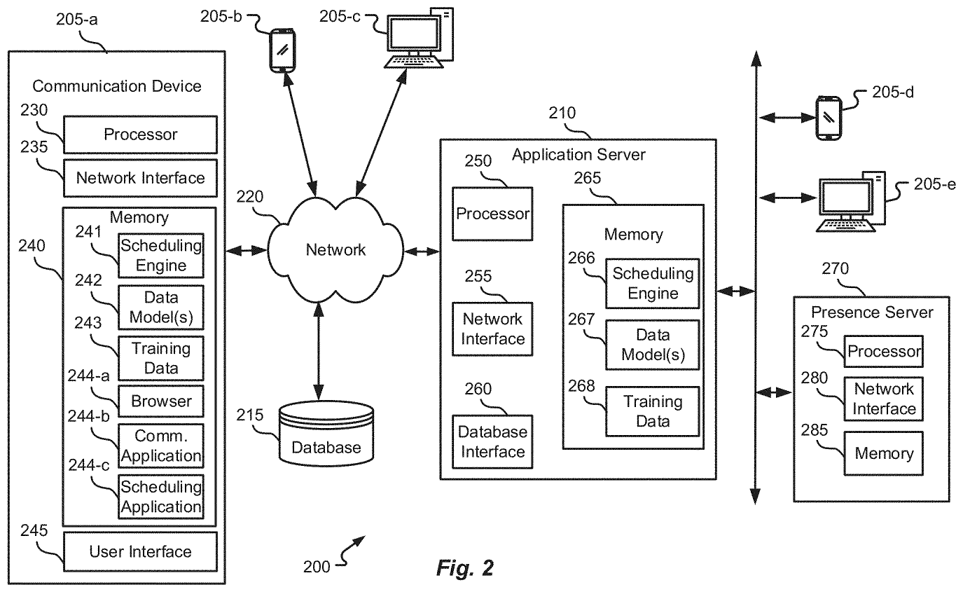

In an example, the application server 110 may be configured to provide application services to the communication devices 105. The application services may include, for example, scheduling services associated with one or more scheduling applications 106 (e.g., calendar applications, meeting scheduler applications). In some other aspects, the application services may include communication services associated with one or more communications applications 107. Example aspects of the scheduling applications 106 and communications applications 107 are described herein with reference to FIG. 2.

The presence server 125 may be in communication with the application server 110. In some aspects, the presence server 125 may provide user presence data (also referred to herein as a user presence information) to the application server 110. In some examples, the application server 110 may receive user presence data from presence agents respectively included in the communication devices 105 and/or the application server 110. The presence agents may be associated, for example, with the communications application 107. In some cases, the presence agents may accept and store information about users. In some cases, presence agents may transmit notifications indicative of presence state changes. Alternatively, or additionally, the presence server 125 (e.g., an application presence component included therein) may provide presence data to the application server 110.

In some aspects, the communication devices 105, the server 110, the database 115, and/or the presence agents may be associated with wired and/or wireless connections. Wired connections, for example, may include Ethernet-based wired local area network (LAN) connections using physical transmission mediums (e.g., coaxial cable, copper cable/wire, fiber-optic cable, etc.). Wireless connections, for example, may include cellular or cellular data connections and protocols (e.g., digital cellular, personal communications service (PCS), cellular digital packet data (CDPD), general packet radio service (GPRS), enhanced data rates for global system for mobile communications (GSM) evolution (EDGE), code division multiple access (CDMA), single-carrier radio transmission technology (1×RTT), evolution-data optimized (EVDO), high speed packet access (HSPA), universal mobile telecommunications service (UMTS), 3G, long term evolution (LTE), 4G, and/or 5G, etc.), Bluetooth, Bluetooth low energy, Wi-Fi, radio, satellite, infrared connections, and/or ZigBee communication protocols.

The presence server 125 may determine the presence data of a user of a communication device 105 based on initiation of an application (e.g., a scheduling application 106, a communications application 106, etc.) by the communication device 105. In an example, upon initiation (e.g., user startup, user logging in) of a communications application 107 by the communication device 105, the communication device 105 may indicate a user presence (also referred to herein as a user status or an availability status) “available” to the presence server 125.

In some aspects, based on user activity and/or user input at the communication device 105, the communication device 105 (e.g., the communications application 107) may indicate user presences to the presence server 125, such as, for example, “busy” or “do not disturb.” In some other aspects, based on user inactivity (e.g., for more than a temporal duration) at the communication device 105, the communication device 105 may indicate a user presence of “inactive” to the presence server 125.

In some cases, based on other user actions at the application on the communication device 105 (e.g., a user exiting or “logging out” the application), the communication device 105 may indicate a user presence “offline” to the presence server 125. In some other cases, the presence server 125 may set the user presence to “offline” for cases in which the presence server 125 does not receive user presence data from the application server 110 for more than a temporal duration (e.g., the communication device 105 is powered off, the communication device 105 enters a sleep mode due to user inactivity). In some examples, the presence server 125 may determine a user presence associated with a communication device 105 based on network presence data of the communication device 105 (e.g., presence data provided over the communication network 120).

The Internet is an example of the communication network 120 that constitutes an Internet Protocol (IP) network consisting of multiple computers, computing networks, and other communication devices located in multiple locations, and components in the communication network 120 (e.g., computers, computing networks, communication devices) may be connected through one or more telephone systems and other means. Other examples of the communication network 120 may include, without limitation, a standard Plain Old Telephone System (POTS), an Integrated Services Digital Network (ISDN), the Public Switched Telephone Network (PSTN), a LAN, a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 120 may include of any combination of networks or network types. In some aspects, the communication network 120 may include any combination of communication mediums such as coaxial cable, copper cable/wire, fiber-optic cable, or antennas for communicating data (e.g., transmitting/receiving data).

Example aspects of components and functionalities of the communication devices 105, the application server 110, the database 115, the communication network 120, and the presence server 125 are provided with reference to FIG. 2.

While the illustrative aspects, embodiments, and/or configurations illustrated herein show the various components of the system 100 collocated, certain components of the system 100 can be located remotely, at distant portions of a distributed network, such as a Local Area Network (LAN) and/or the Internet, or within a dedicated system. Thus, it should be appreciated, that the components of the system 100 can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

FIG. 2 illustrates an example of a system 200 that supports an intelligent meeting scheduling assistant using user activity analysis in accordance with aspects of the present disclosure. In some examples, the system 200 may be implemented by aspects of the system 100 described with reference to FIG. 1. The system 200 may include communication devices 205 (e.g., communication device 205-a through communication device 205-e), an application server 210, a database 215, a communication network 220, and a presence server 270. The communication devices 205, the application server 210, the database 215, the communications network 220, and the presence server 270 may be implemented, for example, by aspects of like elements described with reference to FIG. 1.

The communication network 220 may facilitate machine-to-machine communications between any of the communication device 205 (or multiple communication devices 205), the application server 210, one or more databases (e.g., database 215), and the presence server 270. The communication network 220 may include any type of known communication medium or collection of communication media and may use any type of protocols to transport messages between endpoints. In some aspects, the communication network 220 may include wired communications technologies, wireless communications technologies, or any combination thereof. In an example, the communication devices 205, the application server 210, and the presence server 270 may support communications over the communications network 220 between multiple entities (e.g., users). In some cases, the system 200 may include any number of communication devices 205, and each of the communication devices 205 may be associated with a respective entity.

In various aspects, settings of any of the communication devices 205, the application server 210, or the presence server 270 may be configured and modified by any user and/or administrator of the system 200. Settings may include parameters associated with determining presence data and/or predicting availabilities of users as described herein. Settings may be configured to be personalized for one or more communication devices 205, users of the communication devices 205, and/or other groups of entities, and may be referred to herein as profile settings, user settings, or organization settings. In some aspects, rules and settings may be used in addition to, or instead of, the parameters described herein. In some examples, the rules and/or settings may be personalized by a user and/or administrator for any variable, threshold, user (user profile), communication device 205, entity, or groups thereof.

A communication device 205 (e.g., communication device 205-a) may include a processor 230, a network interface 235, a memory 240, and a user interface 245. In some examples, components of the communication device 205 (e.g., processor 230, network interface 235, memory 240, user interface 245) may communicate over a system bus (e.g., control busses, address busses, data busses) included in the communication device 205. In some cases, the communication device 205 may be referred to as a computing resource.

In some cases, a communication device 205 (e.g., communication device 205-a) may transmit or receive packets to one or more other devices (e.g., another communication device 205, the application server 210, the database 215, the presence server 270) via the communication network 220, using the network interface 235. The network interface 235 may include, for example, any combination of network interface cards (NICs), network ports, associated drivers, or the like. Communications between components (e.g., processor 230, memory 240) of the communication device 205 and one or more other devices (e.g., another communication device 205, the database 215, the presence server 270) connected to the communication network 220 may, for example, flow through the network interface 235.

The processor 230 may correspond to one or many computer processing devices. For example, the processor 230 may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 240 of the communication device 205). For example, upon executing the instruction sets stored in memory 240, the processor 230 may enable or perform one or more functions of the communication device 205.

The processor 230 may utilize data stored in the memory 240 as a neural network. The neural network may include a machine learning architecture. In some aspects, the neural network may be or include any machine learning network such as, for example, a deep learning network, a convolutional neural network, an artificial neural network (ANN), or the like. Some elements stored in memory 240 may be described as or referred to as instructions or instruction sets, and some functions of the communication device 205 may be implemented using machine learning techniques.

The memory 240 may include one or multiple computer memory devices. The memory 240 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 240, in some examples, may correspond to a computer-readable storage media. In some aspects, the memory 240 may be internal or external to the communication device 205.

The memory 240 may be configured to store instruction sets, neural networks, and other data structures (e.g., depicted herein) in addition to temporarily storing data for the processor 230 to execute various types of routines or functions. For example, the memory 240 may be configured to store program instructions (instruction sets) that are executable by the processor 230 and provide functionality of a scheduling engine 241 described herein. The memory 240 may also be configured to store data or information that is usable or capable of being called by the instructions stored in memory 240. One example of data that may be stored in memory 240 for use by components thereof is a data model(s) 242 (also referred to herein as a neural network model) and/or training data 243 (also referred to herein as a training data and feedback).

The scheduling engine 241 may include a single or multiple engines. The communication device 205 (e.g., the scheduling engine 241) may utilize one or more data models 242 for recognizing and processing information obtained from other communication devices 205, the application server 210, the database 215, and the presence server 270. In some aspects, the communication device 205 (e.g., the scheduling engine 241) may build and/or update one or more data models 242 based on learned information included in the training data 243. In some aspects, the scheduling engine 241 and the data models 242 may support forward learning based on the training data 243. The scheduling engine 241 may have access to and use one or more data models 242. For example, the data model(s) 242 may be built and updated by the scheduling engine 241 based on the training data 243. The data model(s) 242 may be provided in any number of formats or forms. Non-limiting examples of the data model(s) 242 include Decision Trees, Support Vector Machines (SVMs), Nearest Neighbor, and/or Bayesian classifiers.

In some examples, the training data 243 may include communication data associated with the communication device 205. In some cases, the communication data may include communication histories (e.g., transmitted communication data) between the communication device 205 and other communication devices 205 (e.g., any of communication device 205-b through communication device 205-e), real-time communication data between the communication device 205 and other communication devices 205, data transmissions between the communication device 205 and the application server 210, etc.

In some aspects, communication histories between a communication device 205 (e.g., communication device 205-a) and another communication device 205 (e.g., communication device 205-b) may include communication between a user of the communication device 205 and a user of the other communication device 205. In some aspects, the training data 243 may include outputs (e.g., predictions) by the scheduling engine 241. In some examples, the training data 243 may include past actions of a user with respect to previous predictions by the scheduling engine 241.

The scheduling engine 241 may be configured to analyze presence data provided by any of the communication devices 205 (e.g., communications application 244-b) and/or the application server 210 (e.g., supporting the communications application 244-b). The presence data may include, for example, historical presence data (e.g., previously communicated by a communication device 205 and/or the presence server 270) or real-time presence data.

In some aspects, the scheduling engine 241 may be configured to analyze scheduling information provided by any of the communication devices 205 (e.g., communications application 244-b, scheduling application 244-c) and/or the application server 210 (e.g., supporting the communications application 244-b and/or the scheduling application 244-c). The scheduling information may include, for example, scheduled calendar events associated with a user of a communication device 205 and details (e.g., content) associated with the scheduled calendar events.

In some other aspects, the scheduling engine 241 may be configured to analyze content provided by any of the communication devices 205 (e.g., communications application 244-b, scheduling application 244-c) and/or the application server 210 (e.g., supporting the communications application 244-b and/or the scheduling application 244-c). The content may include historical content (e.g., previously communicated by a communication device 205 and/or the application server 210) or real-time content.

The scheduling engine 241 may be configured to receive information from other communication devices 205, the application server 210, and/or the presence server 270. The scheduling engine 241 may be configured to analyze and determine activity patterns (also referred to herein as working patterns) associated with one or more users of the communication devices 205. For example, the scheduling engine 241 may determine the activity patterns based on an analysis of presence data (e.g., historical and/or real-time) associated with the one or more users. In some aspects, the scheduling engine 241 may predict activity patterns associated with one or more users based on the analysis of the presence data.

In some examples, a predicted activity pattern for a user may include predicted availabilities of the user for a set of temporal periods. The predicted availabilities may include predictions (e.g., using artificial intelligence, for example, a machine learning network) of whether a user will be in an active status, an inactive status, an offline status, or an intermittent active status at any temporal period (e.g., at different time slots on a target day of the week, a target date, a target month, etc.).

In some aspects, the scheduling engine 241 may build any number of user profiles using automatic processing, using artificial intelligence and/or using input from one or more users associated with the communication devices 205. The scheduling engine 241 may, for example, assign a predicted activity pattern (e.g., predicted statuses with reference to different temporal periods) for each of the user profiles. The user profiles may be associated with, for example, respective entities (users) of different communication devices 205. The scheduling engine 241 may use automatic processing, artificial intelligence, and/or inputs from one or more users of the communication devices 205 to determine, manage, and/or combine information relevant to a user profile.

The scheduling engine 241 may update (e.g., continuously, periodically) user profiles based on new information that is relevant to the user profiles. The scheduling engine 241 may receive new information from any communication device 205, the application server 210, the database 215, the presence server 270, etc. Profile information may be organized and classified in various manners. In some aspects, the organization and classification of profile information may be determined by automatic processing, by artificial intelligence and/or by one or more users of the communication devices 205.

The scheduling engine 241 may store scheduling information associated with users of the communication devices 205. In an example, the scheduling engine 241 may store the scheduling information in the memory 240 (e.g., in a database included in the memory 240), the database 215, and/or memory 265 of the application server 210. The scheduling information may include, for example, scheduled calendar events associated with the users. In some aspects, the scheduling information may include a list of attendees (e.g., hosts, invitees) associated with the scheduled calendar events, contact information associated with the attendees, or any combination thereof. In other aspects, the scheduling information may include temporal information associated with the scheduled calendar events (e.g., start and stop times).

In some examples, the scheduling engine 241 may store content associated with the scheduled calendar events. The content may include, for example, descriptive text information associated with the scheduled calendar events. In some aspects, the content may include attachments (e.g., documents, multimedia data, etc.) associated with a meeting invitation for a scheduled calendar event.

Data within the database of the memory 240 may be updated, revised, edited, or deleted by the scheduling engine 241. In some aspects, the scheduling engine 241 may support continuous, periodic, and/or batch fetching of presence data (e.g., activity data) of users associated with the communication devices 205, the communications applications 244-b, or any combination thereof. The scheduling engine 241 may fetch or receive the presence data from the communication devices 205, the presence server 270, or any combination thereof.

In some other aspects, the scheduling engine 241 may support continuous, periodic, and/or batch fetching of content (e.g., content attached to a meeting invitation, content associated with scheduled calendar event) and content aggregation. The scheduling engine 241 may fetch or receive the content from the communication devices 205, the application server 210, or any combination thereof.

Information stored in the database included in the memory 240 may include and is not limited to communication information, user information, historical analysis information (e.g., previously predicted activity patterns of users, previously predicted availabilities of users for candidate temporal periods, suggested temporal periods associated with previous meeting invitations, etc.), processing information including historical processing information, key words, configurations, settings, variables, and properties. Further, information regarding the relevance of different types of content, as well as how to determine relevance (e.g., rules, settings, source(s) of content, rankings of content, location of key words/phrases, repetition of key words/phrases, definitions of relevance, etc.) or contextual information associated with content may be stored in the database included in the memory 240.

The scheduling engine 241 may create, select, and execute processing decisions. Processing decisions may include, for example, scheduling management and/or content management associated with scheduling information provided by a communication device 205 or the application server 210. Processing decisions may include prediction of activity patterns of users based on presence data provided by a communication device 205, the application server 210, or the presence server 270. In some examples, the prediction of activity patterns of users may be based on scheduling information provided by a communication device 205 or the application server 210.

In some examples, the processing decisions may include predicting available temporal periods for a meeting invitation (e.g., time slots associated with a high availability for an invitee and/or meeting host), displaying suggested temporal periods for a meeting invitation (e.g., based on probability scores and/or confidence scores associated with the predictions), and/or selecting a temporal period for the meeting invitation (e.g., based on the probability scores, confidence scores, and/or forward learning).

In some other aspects, the scheduling engine 241 may create, select, and execute processing operations. The processing operations may include, for example, content extraction, content analysis, and context analysis described herein. In some aspects, the scheduling engine 241 may support natural language processing operations. For example, the scheduling engine 241 and/or the processor 230 (e.g., separately, or in combination) may apply one or more natural language processing operations to content (e.g., descriptive text information, attachments, etc.) associated with scheduled calendar events.

In an example, the scheduling engine 241 and/or the processor 230 may be configured to perform syntactic analysis (e.g., parse, analyze sentence structure, etc.) on text associated with scheduled calendar events. For example, the scheduling engine 241 and/or the processor 230 may parse text included in email messages, meeting invitations, and/or attachments associated with scheduled calendar events. Based on the analysis (e.g., parsing), the scheduling engine 241 and/or the processor 230 may determine contextual information associated with scheduled calendar events.

In some examples, the contextual information may include the location (e.g., coordinates) of an attendee on the date of a scheduled calendar event and/or the location of the scheduled calendar event. In some aspects, the contextual information may include the number of meetings a user has scheduled for the same date. In some other aspects, the contextual information may include subject matter (e.g., meeting topics) associated with each scheduled calendar event. In some examples, based on the contextual information of a scheduled calendar event, the scheduling engine 241 and/or the processor 230 (e.g., a machine learning network implemented by the scheduling engine 241 and/or the processor 230) may determine or identify a priority (e.g., importance level) associated with the scheduled calendar event. The processing decisions and/or processing operations described herein may be performed automatically by the scheduling engine 241, with or without human input.

The communication device 205 may render a presentation (e.g., visually, audibly, using haptic feedback, etc.) of an application 244 (e.g., a browser application 244-a, a communications application 244-b, a scheduling application 244-c). In an example, the communication device 205 may render the presentation via the user interface 245. The user interface 245 may include, for example, a display (e.g., a touchscreen display), an audio output device (e.g., a speaker, a headphone connector), or any combination thereof. In some aspects, the applications 244 may be stored on the memory 240. In some cases, the applications 244 may include cloud-based applications or server-based applications (e.g., supported and/or hosted by the application server 210). Settings of the user interface 245 may be partially or entirely customizable and may be managed by one or more users, by automatic processing, and/or by artificial intelligence.

In an example, any of the applications 244 (e.g., browser application 244-a, communication application 244-b, scheduling application 244-c) may be configured to receive data in an electronic format and present content of data via the user interface 245. For example, the applications 244 may receive data from another communication device 205, the application server 210, or the presence server 270 via the communications network 220, and the communication device 205 may display corresponding content via the user interface 245.

For example, the communication device 205 may support the transmission and reception of communications (e.g., instant messages, calls, document transmissions) by a user via the communications application 244-b. In some cases, the communications application 244-b may be referred to as an integrated communications application. For example, the communications application 244-b may support integrated audio, video, and text communications between communication devices 105. In some cases, the communications applications 244-b may support instant messaging (e.g., including text data, audio, video, etc.), availability services (e.g., presence monitoring), roster management services. In some aspects, the communications application 244-b may be integrated with a VOIP application. In some cases, the communications application 244-b may be a social media application supportive of integrated audio, video, and text communications and availability services (e.g., presence monitoring).

In some examples, the communications application 244-b may monitor and indicate a presence (e.g., an activity status) of the user of the communication device 205.

An activity status may be, for example, an “online” status (also referred to herein as an “active” status), an “offline” status, an “away” status (also referred to herein as an “inactive” status), a “do not disturb” status (also referred to herein as a “busy” status), an “on a call” status, or an “intermittent active” status (also referred to herein as an “intermittent available” status). In some cases, an “intermittent active” status may be associated with multiple transitions between different activity statuses (e.g., “online” status, “do not disturb” status, “away” status, etc.) during a temporal period.

In some other aspects, the communications application 244-b may monitor and indicate presence of contacts associated with a user profile of the user. In some cases, the communications application 244-b may receive presence information from other communication devices 205 and/or the presence server 270, based on which the communications application 244-b may indicate the presence of each contact. The communications application 244-b may include example aspects of the communications application 107 described with reference to FIG. 1.

The scheduling application 244-c may support the creation, storage, organization, and viewing of meeting dates and appointments. In some aspects, the scheduling application 244-c may include task management features supportive the creation, storage, organization, and viewing of tasks according to various time schedules. In some cases, the scheduling application 244-c may support displaying meeting date and appointments in combination with the tasks. In some cases, the scheduling application 244-c may be a standalone scheduling application (e.g., a calendar application). In some aspects, the scheduling application 244-c may be integrated with the communications application 244-b. The scheduling application 244-c may include example aspects of the scheduling application 106 described with reference to FIG. 1.

In some examples, the communication device 205 may identify meeting invitations (e.g., calendar events) created by a user of the communication device 205 via the scheduling application 244-c. In some examples, the communication device 205 may identify meeting invitations accepted and/or rejected by the user. In some aspects, the communication device 205 may identify tasks created by and/or assigned to the user. The scheduling application 244-c may output or display content (e.g., text descriptions) and/or temporal details associated with meeting invitations, scheduled calendar events, and/or tasks.

The database 215 may include a relational database, a centralized database, a distributed database, an operational database, a hierarchical database, a network database, an object-oriented database, a graph database, a NoSQL (non-relational) database, etc. In some aspects, the database 215 may store and provide access to, for example, any of the stored data described herein.

The application server 210 may include a processor 250, a network interface 255, database interface instructions 260, and a memory 265. In some examples, components of the application server 210 (e.g., processor 250, network interface 255, database interface 260, memory 265) may communicate over a system bus (e.g., control busses, address busses, data busses) included in the application server 210. The processor 250, network interface 255, and memory 265 of the application server 210 may include examples of aspects of the processor 230, network interface 235, and memory 240 of the communication device 205 described herein.

For example, the processor 250 may be configured to execute instruction sets stored in memory 265, upon which the processor 250 may enable or perform one or more functions of the application server 210. In some aspects, the processor 250 may utilize data stored in the memory 265 as a neural network. In some examples, the application server 210 may transmit or receive packets to one or more other devices (e.g., a communication device 205, the database 215, another application server 210, the presence server 270) via the communication network 220, using the network interface 255. Communications between components (e.g., processor 250, memory 265) of the application server 210 and one or more other devices (e.g., a communication device 205, the database 215, the presence server 270) connected to the communication network 220 may, for example, flow through the network interface 255.

In some examples, the database interface instructions 260 (also referred to herein as database interface 260), when executed by the processor 250, may enable the application server 210 to send data to and receive data from the database 215. For example, the database interface instructions 260, when executed by the processor 250, may enable the application server 210 to generate database queries, provide one or more interfaces for system administrators to define database queries, transmit database queries to one or more databases (e.g., database 215), receive responses to database queries, access data associated with the database queries, and format responses received from the databases for processing by other components of the application server 210.

The memory 265 may be configured to store instruction sets, neural networks, and other data structures (e.g., depicted herein) in addition to temporarily storing data for the processor 250 to execute various types of routines or functions. For example, the memory 265 may be configured to store program instructions (instruction sets) that are executable by the processor 250 and provide functionality of the scheduling engine 266 described herein. One example of data that may be stored in memory 265 for use by components thereof is a data model(s) 267 (also referred to herein as a neural network model) and/or training data 268. The data model(s) 267 and the training data 268 may include examples of aspects of the data model(s) 242 and the training data 243 described with reference to the communication device 205.

For example, the application server 210 (e.g., the scheduling engine 266) may utilize one or more data models 267 for recognizing and processing information obtained from communication devices 205, another application server 210, the database 215, and the presence server 270. In some aspects, the application server 210 (e.g., the scheduling engine 266) may build and/or update one or more data models 267 based on learned information included in the training data 268. In some aspects, components of the scheduling engine 266 may be provided in a separate engine in communication with the application server 210.

In an example, the presence server 270 may include a processor 275, a network interface 280, and a memory 285. In some examples, components of the presence server 270 (e.g., processor 275, network interface 280, memory 285) may communicate over a system bus (e.g., control busses, address busses, data busses) included in the presence server 270. The processor 275, network interface 280, memory 285 may include examples of aspects of like components described herein.

The presence server 270 may provide user presence data (also referred to herein as a user presence information) to the application server 210 (e.g., supporting the communications application 244-b). In some examples, the application server 210 may receive user presence data from presence agents included in the communication devices 205 and/or the application server 210. For example, the presence server 270 may record and aggregate presence data (e.g., user activity, user inactivity) associated with communications application 244-b. The presence data may include, for example, historical presence data (e.g., previously recorded presence data) or real-time presence data. The memory 285 may be configured to store program instructions (instruction sets) that are executable by the processor 275 and provide functionality of the presence server 270 described herein.

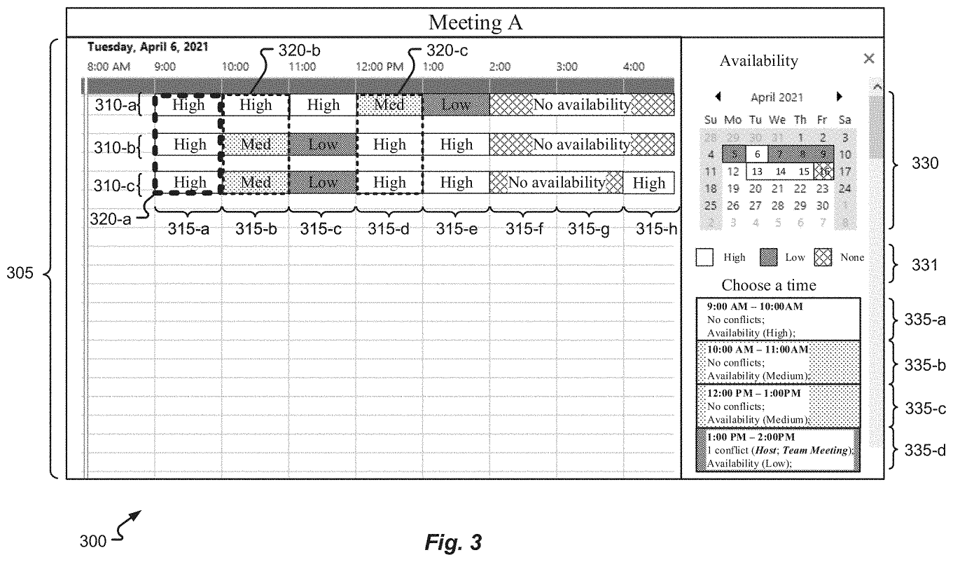

FIG. 3 illustrates an example of a scheduling interface 300 that supports an intelligent meeting scheduling assistant using user activity analysis in accordance with aspects of the present disclosure. The scheduling interface 300 may be implemented by examples of aspects of a communication device 105 or a communication device 205 described with reference to FIGS. 1 and 2.

The scheduling interface 300 may be associated with a scheduling application (e.g., a scheduling application 244-c described with reference to FIG. 2). In an example, the scheduling interface 300 may include a date view 305 and a month view 330. In some aspects, the scheduling interface 300 may be customizable (e.g., based on user preferences, user inputs, etc.). For example, the scheduling interface 300 may display any combination of views based on one or more temporal parameters (e.g., the date view 305, a weekly view, a bi-weekly view, the month view 330, a yearly view, etc. Example aspects of the present disclosure are described herein with reference to the communication devices 205, the application server 210, the presence server 270, and the scheduling interface 300 of FIGS. 2 and 3.

According to example aspects of the present disclosure, a communication device 205 (e.g., communication device 205-a) may support one or more machine learning techniques for automatically learning activity patterns (also referred to herein as a working patterns) of multiple users (e.g., one or more meeting hosts, one or more invitees). In some aspects, the communication device 205 (e.g., a machine learning network implemented by the processor 230 and/or the scheduling engine 241) may support suggesting one or more temporal periods 315 (also referred to herein as meeting times, time slots, and/or time periods) for a meeting based on the learned activity patterns. In some examples, the communication device 205 may display predicted availabilities (e.g., high availability, medium availability, low availability, no availability) respectively associated with one or more temporal periods 315 and the users. In some aspects, the communication device 205 may provide or output a report indicating patterns associated with the predicted availabilities.

The communication device 205 may support the prediction of candidate temporal periods (e.g., temporal period 315-a through candidate temporal period 315-h) for users based on the learned activity patterns. For example, the communication device 205 may identify a meeting invitation created at the communication device 205 (e.g., by a user of the communication device 205). The communication device 205 may identify users (e.g., one or more hosts, one or more invitees) associated with the meeting invitation.

In an example, the communication device 205 may determine presence data associated with the identified users. For example, the communication device 205 may receive or access activity data associated with the users with respect to one or more temporal durations, from one or more data sources (e.g., the communications application 244-b, the application server 210, the presence server 270, a presence agent, etc.). In an example, the communication device 205 may receive or access activity data with respect to one or more temporal periods of any duration (e.g., a configured number of days, weeks, months, years, etc.). In some aspects, the activity data may be historical activity data inclusive of different activity statuses (e.g., “online,” “offline,” “away,” “do not disturb,” “on a call,” “inactive,” “intermittent active,” etc.) of the users with respect to different temporal periods.

The communication device 205 may provide at least a portion of the presence data to a machine learning network (e.g., a machine learning network implemented by the scheduling engine 241, the scheduling engine 266, or the presence server 270). In an example, the communication device 205 may provide the presence data (or portion thereof) to the machine learning network based on receiving a user input (e.g., via the user interface 245) associated with creating a meeting invitation. Alternatively, or additionally, the communication device 205 may provide portions of the presence data in real-time, for example, as the user is inputting information associated with the meeting invitation (e.g., adding invitees, inputting descriptive details of the meeting invitation, etc.).

In an example, the machine learning network may generate an output based on an analysis of the presence data (or portion thereof). For example, based on the analysis of the presence data, the machine learning network may generate an output that includes a predicted activity pattern for one or more users. In some examples, the output (e.g., the predicted activity pattern) may include predicted availabilities of users for different temporal periods 315 (e.g., any of temporal period 315-a through temporal period 315-h). In some aspects, the temporal periods 315 may be referred to as candidate temporal periods.

The predicted availabilities may be indicated by the machine learning network, for example, as a “high availability” (e.g., a predicted availability above a first threshold), a “medium availability” (e.g., a predicted availability above a second threshold but below the first threshold), a “low availability” (e.g., a predicted availability above a third threshold but below the second threshold), and “no availability” (e.g., a predicted availability below a fourth threshold) of the users with respect to the different temporal periods 315. In some cases, the predicted availabilities may be indicated by the machine learning network as percentage values. In some aspects, the predicted availabilities may include predicted availability statuses (e.g., “predicted to be online,” “predicted to be offline,” “predicted to be away,” “predicted to be busy,” “predicted do not disturb,” “predicted inactive,” “predicted intermittent active,” etc.) of the users with respect to the different temporal periods 315.

According to example aspects of the present disclosure, the machine learning network may generate the output (e.g., predicted availabilities, predicted availability statuses, percentage values, etc.) based on any quantity or any combination of parameters (e.g., presence data and/or other parameters). For example, the machine learning network may generate the output based on any data provided or received from the communication device 205, another communication device 205, the system 200, and/or the presence server 270. The parameters may include any combination of parameters such as, but not limited to, presence data, time zone information, scheduling information (e.g., scheduled calendar events associated with the scheduling application 244-c), content associated with the scheduling information, and/or contextual information associated with the scheduling information.

In an example, the communication device 205 may determine time zone information associated with the identified users (e.g., meeting hosts, invitees). The time zone information may include, for example, an indication of a time zone (e.g., any region where the same standard time is kept) associated with each user. In an example, the communication device 205 may provide the time zone information to the machine learning network. For example, the communication device 205 may provide the time zone information to the machine learning network based on a user input (e.g., via the user interface 245) associated with creating a meeting invitation.

Alternatively, or additionally, the communication device 205 may provide the time zone information for one or more users (e.g., meeting host, meeting co-host, invitees) automatically or in real-time, for example, as a user (e.g., meeting host) is inputting information associated with the meeting invitation (e.g., adding invitees, viewing potential dates and times for the meeting invitation, etc.). The machine learning network may generate an output inclusive of candidate temporal periods (e.g., any of temporal period 315-a through temporal period 315-h) based on an analysis of the time zone information. For example, based on the time zone information, the machine learning network may identify candidate temporal periods associated with predicted working hours of the users.

In another example, the communication device 205 may determine scheduling information associated with the identified users (e.g., meeting hosts, invitees). In some aspects, the communication device 205 may determine the scheduling information from the scheduling application 244-c, the application server 210, and/or another communication device 205. In an example, the scheduling information may include scheduled calendar events associated with any of the identified users and another meeting invitation (e.g., a confirmed calendar event).

The communication device 205 may provide the scheduling information to the machine learning network. In some aspects, the communication device 205 may determine and provide contextual information associated with the scheduling information to the machine learning network. In some other aspects, the machine learning network may determine the contextual information based on an analysis of the scheduling information.

In an example, the communication device 205 may provide the scheduling information and/or associated contextual information to the machine learning network based on a user input (e.g., via the user interface 245) associated with creating a meeting invitation. Alternatively, or additionally, the communication device 205 may provide the scheduling information and/or contextual information automatically or in real-time, for example, as a user (e.g., meeting host) is inputting information associated with the meeting invitation (e.g., adding invitees, viewing potential dates and times for the meeting invitation, etc.). In an example, the machine learning network may generate an output inclusive of candidate temporal periods (e.g., any of temporal period 315-a through temporal period 315-h) based on an analysis of the scheduling information and/or contextual information.

For example, the machine learning network may extract and analyze the scheduling information (e.g., scheduled calendar events, attendees associated with the scheduled calendar events, temporal periods associated with the scheduled calendar event), based on which the machine learning network may identify any temporal periods 315 for which a user (e.g., meeting host, invitee) already has a scheduled calendar event. In an example, the machine learning network may identify scheduled calendar events that at least partially overlap a candidate temporal period (e.g., any of temporal period 315-a through temporal period 315-h).

In another example, the communication device 205 and/or machine learning network may apply one or more natural language processing operations described herein to content (e.g., descriptive text information, multimedia data attached to a meeting invitation, etc.) associated with scheduled calendar events. For example, communication device 205 and/or the machine learning network may determine the contextual information using natural language processing techniques such as linguistic context recognition, word recognition, etc.

In some examples, the communication device 205 and/or machine learning network may perform syntactic analysis (e.g., parse, analyze sentence structure, etc.) described herein on text associated with scheduled calendar events. For example, the machine learning network may support text scanning, searching, parsing, and/or analysis (including performing semantic and/or syntactic analysis). In an example, the machine learning network may support recognition of key words (e.g., names) associated with the contextual information. In some examples, the machine learning network may divide and/or subdivide text content into portions based on paragraphs, sentences, sections, types of content, etc.

In an example, for a scheduled calendar event associated with a temporal period 315 and a user, the machine learning network (e.g., included in or implemented by the scheduling engine 241, the scheduling engine 266, etc.) may analyze the content and/or associated contextual information of the scheduled calendar event. Based on the analysis, the machine learning network may determine a relative priority or importance associated with the scheduled calendar event. For example, the machine learning network may categorize a scheduled calendar event as having a relative importance (e.g., high importance, medium importance, low importance) based on the content and/or contextual information. In some aspects, based on the relative importance, the machine learning network may predict and/or modify a corresponding availability of the user with reference to the temporal period 315. Accordingly, for example, the machine learning network may generate an output inclusive of candidate temporal periods (e.g., any of temporal period 315-a through temporal period 315-h) based on presence data, time zone information, scheduling information and/or contextual information described herein.

For example, based on presence data associated with a user (e.g., meeting host, invitee), the machine learning network may predict that the user may have a “high availability” for a temporal period 315. The machine learning network may further identify, from scheduling information, whether any scheduled calendar events overlap (e.g., in time) the temporal period 315. In some aspects, based on content and/or contextual information associated with a scheduled calendar event that overlaps the temporal period 315, the machine learning may modify the predicted availability for the temporal period 315.

In an example, if the content and/or contextual information indicates that the scheduled calendar event has a relatively high importance (e.g., a client meeting), the machine learning network may change the availability of the user from “high availability” to “no availability” for the temporal period 315. Alternatively, or additionally, if the content and/or contextual information indicates that the scheduled calendar event has a relatively low importance (e.g., coffee break with a colleague), the machine learning network may change the availability of the user from “high availability” to “medium availability” for the temporal period 315.

In some aspects, the machine learning network may assign and/or configure a weighting factor to any of the example parameters described herein (e.g., presence data, time zone information, scheduling information, contextual information, thresholds associated with probability scores, thresholds associated with confidence scores). The machine learning network may apply any or all of the weighting factors when predicting user availabilities with reference to candidate temporal periods (e.g., any of temporal period 315-a through temporal period 315-h). The machine learning network may support any combination of criteria, thresholds, and/or weighting factors.

The communication device 205 may display one or more suggested temporal periods (e.g., one or more of the temporal period 315-a through temporal period 315-h) for a meeting invitation based on the output from the machine learning network. For example, the communication device 205 may display a predicted availability pattern 310-a associated with a first user (e.g., a meeting host), a predicted availability pattern 310-b associated with a second user (e.g., a first invitee, a meeting co-host, etc.), and a predicted availability pattern 310-c associated with a third user (e.g., a second invitee). In some examples, the communication device 205 may display predicted availabilities (e.g., “high availability,” “medium availability,” “low availability,” “no availability”), percentage values associated with the predicted availabilities (e.g., an X % chance of availability), and/or predicted availability statuses (e.g., “predicted to be online,” “predicted to be offline,” “predicted to be away,” “predicted to be busy,” etc.) associated with the users.

In some examples, the communication device 205 may display or indicate the predicted activity patterns 310, the predicted availabilities, and/or the predicted availability statuses using any type of indicator (e.g., any combination of text, abbreviated text, symbols, markers, colors, etc.). In some cases, the communication device 205 may display or indicate the predicted activity patterns 310, the predicted availabilities, and/or the predicted availability statuses separately or in combination (e.g., overlapping, adjacent to one another, etc.).

In some aspects, the communication device 205 may display or suggest temporal periods 315 for which the predicted availabilities of all users (e.g., meeting hosts, invitees) associated with a meeting invitation satisfies a criterion. For example, the communication device 205 may display or suggest temporal periods 315 having “high availability” for all users. In an example, the communication device 205 may display or suggest temporal period 315-a (e.g., “high availability” for all users), while refraining from displaying or suggesting temporal period 315-b through temporal period 315-h.

In some other aspects, the communication device 205 may display or suggest temporal periods 315 having “medium availability” or higher for all users (e.g., meeting hosts, invitees) associated with the meeting invitation. For example, the communication device 205 may display or suggest temporal period 315-a, temporal period 315-b, and temporal period 315-d (e.g., “medium availability” or higher for all users), while refraining from displaying or suggesting remaining temporal periods 315 (e.g., temporal period 315-c, temporal period 315-e through temporal period 315-h).

In other aspects, the communication device 205 may refrain from displaying or suggesting temporal periods 315 in which at least one user has “no availability.” For example, the communication device 205 may refrain from displaying or suggesting temporal period 315-f through temporal period 315-h.

Alternatively, or additionally, the communication device 205 display all temporal periods 315 in combination with all predicted availabilities of the users with respect to the temporal periods 315. In an example, the communication device 205 may display multiple temporal periods 315, in combination with indicators 320 for temporal periods 315 for which the predicted availabilities of all users (e.g., meeting hosts, invitees) associated with a meeting invitation satisfies a criterion (or set of criteria). In some example aspects, the indicators 320 may be adjacent, overlap, and/or highlight any portion of a temporal period 315 for which the predicted availabilities satisfy the criterion.

For example, based on the output (e.g., predicted availabilities) from the machine learning network, the communication device 205 may identify that the temporal period 315-a has a “high availability” for all users, the temporal period 315-b has a “medium availability” or higher for all users, and the temporal period 315-d has a “medium availability” or higher for all users. The communication device 205 may display an indicator 320-a for the temporal period 315-a having “high availability” for all users, an indicator 320-b for the temporal period 315-b having a “medium availability” or higher for all users, and an indicator 320-c for the temporal period 315-c having a “medium availability” or higher for all users.

In some aspects, the communication device 205 may modify the indicator 320 associated with a temporal period 315 based on the predicted availabilities of the users for the temporal period 315. For example, the communication device 205 may display a different line thickness (e.g., larger thickness), a different color (e.g., green), and/or a different pattern, etc. for the indicator 320-a compared to a line thickness (e.g., larger thickness), color (e.g., orange), and/or pattern, etc. displayed for the indicator 320-b and the indicator 320-c.

In another aspect, for temporal periods 315 each meeting the same criterion (or set of criteria) for all users, the communication device 205 may modify indicators 320 (e.g., modify respective line thicknesses, colors, patterns, etc.) based on a configurable priority associated with the users (e.g., prioritizing according to a meeting host, required attendees, optional attendees, etc.). For example, for temporal period 315-b and temporal period 315-d each having a “medium availability” or higher for all users, the communication device 205 may modify the indicator 320-b and indicator 320-c (e.g., modify respective line thicknesses, colors, patterns, etc.) based on a configurable priority associated with the users.

For example, the communication device 205 may modify the indicator 320-b to indicate that temporal period 315-b has a relatively higher predicted availability of the first user (e.g., meeting host) compared to the second and third users (e.g., invitees), prioritizing the availability of a meeting host. Alternatively, or additionally, the communication device 205 may modify the indicator 320-c to indicate that temporal period 315-d has relatively higher predicted availabilities of the second and third users (e.g., invitees) compared to the first user (e.g., meeting host), prioritizing the availability of invitees.

In some aspects, the communication device 205 may display indicators 331 with respect to the month view 330 (or a weekly view, yearly view, etc.) to indicate dates for which the predicted availabilities of all users (e.g., meeting hosts, invitees) associated with a meeting invitation satisfies a criterion (e.g., “high availability,” a “medium availability” or higher, a “low availability” or higher, “no availability”). Referring to the month view 330, for example, the communication device 205 may indicate that all users (e.g., meeting host, invitees) have “high availability” for at least one temporal period 315 on Apr. 6, 2021 and Apr. 13, 2021 through Apr. 15, 2021. In another example, the communication device 205 may indicate that at least one user (e.g., meeting host, invitees) has “no availability” for temporal periods 315 on Apr. 16, 2021. In some examples, the communication device 205 may indicate that all users (e.g., meeting host, invitees) have at least a “low availability” or higher for at least one temporal period 315 on Apr. 5, 2021 and Apr. 7, 2021 through Apr. 9, 2021.

In some other aspects, the communication device 205 may display scheduling details 335 corresponding to temporal periods (e.g., one or more of the temporal period 315-a through temporal period 315-h) suggested or displayed by the communication device 205. For example, scheduling details 335-a may correspond to the temporal period 315-a, scheduling details 335-b may correspond to the temporal period 315-b, scheduling details 335-c may correspond to temporal period 315-d, and scheduling details 335-d may correspond to temporal period 315-e.

In some examples, the communication device 205 may display scheduling information associated with any scheduled calendar events that may overlap with a temporal period 315. For example, the machine learning network may predict a “low availability” for the temporal period 315-e based on a scheduled calendar event associated with the first user (e.g., meeting host). In an example, the scheduling details 335-d may include an indication of the scheduled calendar event (e.g., “1 conflict (Host, Team Meeting).”

According to example aspects of the present disclosure, based on a user input selecting a temporal period 315 (e.g., temporal period 315-a) from among temporal periods 315 (e.g., temporal period 315-a, temporal period 315-b, temporal period 315-d) suggested by the communication device, the communication device 205 may transmit the meeting invitation to a communication devices 205 associated other users (e.g., meeting co-hosts, invitees, etc.). For example, based on a user input by the first user (e.g., meeting host) selecting the temporal period 315-a, the communication device 205 may transmit the meeting invitation to communication devices 205 associated with other users (e.g., meeting co-hosts, invitees, etc.). In some aspects, the meeting invitation may include an indication of the temporal period 315-a.

In some aspects, the machine learning network (e.g., included in or implemented by the scheduling engine 241, the scheduling engine 266, etc.) may calculate probability scores (e.g., from 0.00 to 1.00) associated with the predicted availability patterns 310, predicted availabilities, and/or predicted availability statuses described herein with reference to the temporal periods 315. In an example, the machine learning network may calculate confidence scores (e.g., from 0.00 to 1.00) respectively corresponding to the probability scores.

For example, the communication device 205 may display an indicator 320 (e.g., an indicator 320-a, an indicator 320-b) described herein for temporal periods 315 having a probability score that satisfies (e.g., is greater than or equal to) a probability score threshold and/or a confidence score that satisfies (e.g., is greater than or equal to) a confidence score threshold. Alternatively, or additionally, the communication device 205 may refrain from displaying an indicator 320 for temporal periods 315 having a probability score that fails to satisfy (e.g., is less than) the probability score threshold and/or a confidence score that fails to satisfy (e.g., is less than) the confidence score threshold.

For example, the communication device 205 may display or suggest temporal periods 315 having a probability score that satisfies (e.g., is greater than or equal to) a probability score threshold and/or a confidence score that satisfies (e.g., is greater than or equal to) a confidence score threshold. Alternatively, or additionally, the communication device 205 may refrain from displaying or suggesting temporal periods 315 having a probability score that fails to satisfy (e.g., is less than) the probability score threshold and/or a confidence score that fails to satisfy (e.g., is less than) the confidence score threshold.

In some aspects, the communication device 205 may display or suggest temporal periods 315 and/or display respective indicators 320 for temporal periods 315 that satisfy a predicted availability criteria (e.g., “high availability”), and for which the predicted availabilities satisfy a probability score threshold and/or confidence score threshold.

In some example aspects, the machine learning network (e.g., included in or implemented by the scheduling engine 241, the scheduling engine 266, etc.) may support forward learning based on training data. For example, the communication device 205 may support forward learning based on outputs (e.g., predicted availabilities with respect to temporal periods 315, candidate temporal periods among the temporal periods 315, etc.). In some examples, the communication device 205 may support forward learning based on past actions of a user (e.g., a meeting host, meeting co-host, invitee) with respect to previous meeting invitations. In some examples, the past actions may include proposed meeting times, meeting acceptances, meeting rejections, and/or proposed alternative meeting times, and the example actions are not limited thereto. Based on the forward learning, the communication device 205 may provide increased accuracy when providing suggested temporal periods 315 in an analysis report.

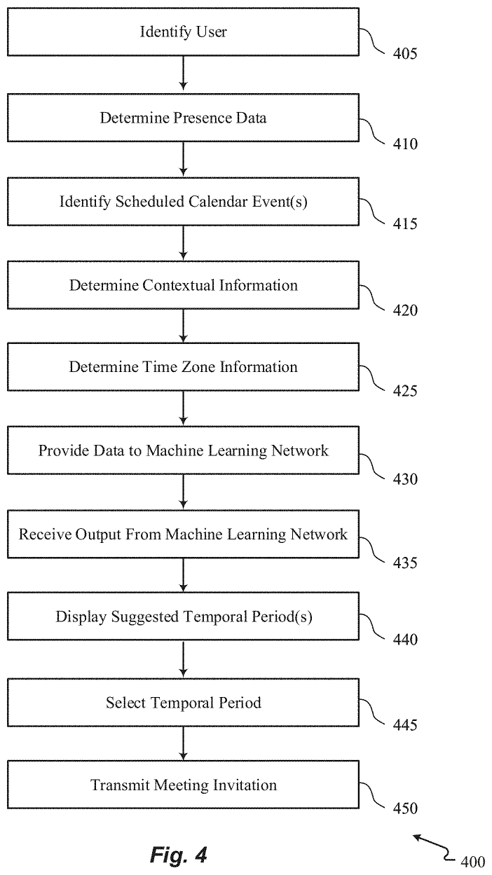

FIG. 4 illustrates an example of a process flow 400 that supports an intelligent meeting scheduling assistant using user activity analysis in accordance with aspects of the present disclosure. In some examples, process flow 400 may implement aspects of a communication device 105, an application server 110, a presence server 125, a communication device 205, an application server 210, a presence server 270, or a scheduling interface 300 described with reference to FIGS. 1, 2, and 3.

In the following description of the process flow 400, the operations may be performed in a different order than the order shown, or the operations may be performed in different orders or at different times. Certain operations may also be left out of the process flow 400, or other operations may be added to the process flow 400. It is to be understood that while the communication device 105 is described as performing a number of the operations of process flow 400, any device (e.g., another communication device 105, an application server 110, or a combination of a communication device 105 and an application server 110) may perform the operations shown.

According to example aspects of the present disclosure, at 405, a communication device 105 may identify at least one user associated with a meeting invitation. The at least one user associated with the meeting invitation may include at least one meeting host, at least one meeting invitee, or a combination thereof.

At 410, the communication device 105 may determine presence data associated with the at least one user. In some aspects, determining the presence data may include aggregating activity data associated with the at least one user over a temporal duration, from one or more data sources. In some examples, the one or more data sources may include: a communication application; an instant messaging application; an application server associated with the communication application, the instant messaging application, or both; a presence server associated with the communication application, the instant messaging application, or both; a presence agent associated with the communication application, the instant messaging application, or both; or a combination thereof.

At 415, the communication device 105 may identify at least one scheduled calendar event associated with the at least one user and another meeting invitation. The at least one scheduled calendar event, for example, may at least partially overlap a candidate temporal period of the set of candidate temporal periods.

At 420, the communication device 105 may determine contextual information associated with the at least one scheduled calendar event. In some aspects, determining the contextual information may include applying one or more language processing operations to content associated with the at least one scheduled calendar event.

At 425, the communication device 105 may determine time zone information associated with the at least one user.

At 430, the communication device 105 may provide data to the machine learning network. For example, at 430, the communication device 105 may provide at least a portion of the presence data to a machine learning network. In some aspects, at 430, the communication device 105 may provide the at least one scheduled calendar event to the machine learning network. In some examples, at 430, the communication device 105 may provide the contextual information to the machine learning network. In some cases, at 430, the communication device 105 may provide the time zone information to the machine learning network.

At 435, the communication device 105 may receive an output from the machine learning network. The output may include a predicted availability of the at least one user for each candidate temporal period of a set of candidate temporal periods. In an example, the output from the machine learning network may include, for each candidate temporal period of the set of candidate temporal periods, at least one of: a probability score associated with the predicted availability of the at least one user; and a confidence score associated with the probability score. The predicted availability may include an active status, an inactive status, an offline status, or an intermittent active status of the at least one user.

In an example, receiving the output from the machine learning network may occur in response to the machine learning network processing at least the portion of the presence data. In some examples, receiving the output from the machine learning network may occur in response to the machine learning network processing temporal information associated with the at least one scheduled calendar event.

In some cases, receiving the output from the machine learning network may occur in response to the machine learning network processing the contextual information, and the output from the machine learning network may be based on a weighting factor associated with the contextual information. In some aspects, receiving the output from the machine learning network may occur in response to the machine learning network processing the time zone information.

At 440, the communication device 105 may display one or more suggested temporal periods for the meeting invitation, from among the set of candidate temporal periods, based on the output from the machine learning network.

In some aspects, displaying the one or more suggested temporal periods may include displaying, for the one or more suggested temporal periods: the predicted availability of the at least one user; scheduling information associated with the at least one user; or both. In some examples, displaying the one or more suggested temporal periods may be based on the probability scores, the confidence scores, or both.

At 445, the communication device 105 may select a temporal period from among the one or more suggested temporal periods, based on the output from the machine learning network.

At 450, the communication device 105 may transmit the meeting invitation to a device associated with the at least one user based on the selecting, the meeting invitation including an indication of the selected temporal period.

In some example aspects not illustrated in the process flow 400, the communication device 105 may support training the machine learning network based on training data, the training data including: a temporal period selected by the at least one user, the machine learning network, or both in association with one or more other meeting invitations; one or more previous outputs by the machine learning network; or a combination thereof.

In some aspects, the methods, devices, and systems described herein may be applied to scheduling application clients, communications application clients, email clients, instant messaging clients, other types of messaging clients, and social media platforms.

Artificial intelligence, including the utilization of machine learning, can be used in various aspects disclosed herein. For example, as discussed, various levels of content can be analyzed and classified, and this can be configurable by artificial intelligence and/or by user preference. Artificial intelligence, as used herein, includes machine learning. Artificial intelligence and/or user preference can configure information that is used to analyze content and identify relationships between content. For example, artificial intelligence and/or user preference can determine which information is compared to content in order to analyze the content. Artificial intelligence and/or user preference may also be used to configure user profile(s), which may be used to determine relevance to a user (e.g., the user associated with the user profile), a communication (e.g., message, social media posting), a messaging window, and/or an application by comparing the content to information contained within the user profile.

Some embodiments utilize natural language processing in the methods and systems disclosed herein. For example, machine learning models can be trained to learn what information is relevant to a user or different users. Machine learning models can have access to resources on a network and access to additional tools to perform the systems and methods disclosed herein.

In certain embodiments, data mining and machine learning tools and techniques will discover information used to determine content and/or contextual information. For example, data mining and machine learning tools and techniques will discover user information, user preferences, relevance of content, levels of relevance, contextual information, key word(s) and/or phrases, thresholds, comparison(s) to threshold(s), configuration(s) of content organization of content, and configuration(s) of a user interface, among other embodiments, to provide improved content analysis and/or contextual analysis.

Machine learning may manage one or more types of information (e.g., user profile information, communication information, etc.), types of content (including portions of content within communication information), comparisons of information, levels of relevance, and organization (including formatting of content). Machine learning may utilize all different types of information. The information can include various types of visual information, documents (including markup languages like Hypertext Markup Language (HTML)), and audio information (e.g., using natural language processing). Inputs and outputs, as described herein, may be managed by machine learning. Machine learning may determine variables associated with information, and compare information (including variables within the information) with thresholds to determine relevance. The relevance may determine content organization based on rules associated with the relevance. Machine learning may manage properties (including formatting, hiding and/or reorganizing) and configurations of the organized content. Any of the information and/or outputs may be modified and act as feedback to the system.

In some aspects, methods and systems disclosed herein use information to analyze content and contextual information. Relevance, and variations thereof, can refer to a determination of how closely a piece of information relates to another piece of information. For example, information may be information that is related to a user, and includes and is not limited to user profile information, association with groups, and information from interactions of the user. Information that is related to a user may be obtained from groups or entities associated with the user. Artificial intelligence and/or user preferences may determine the information that is relevant to a user. For example, artificial intelligence and/or user preference may determine what information is relevant (e.g., appropriate, inappropriate, related) to one or more users, communications, messaging windows, messaging applications, social media applications, etc. Artificial intelligence may use the information to build a profile associated with one or more users, where the profile defines what information (or variables within the information) is relevant to the user, previous communications with the user, current communications generated by the user, and other properties of the relevance (e.g., type of relevance (importance, priority, rank, etc.), level of relevance, etc.). Artificial intelligence and/or user preference may use the profile to compare information with content of a communication to determine relevance between the content (including any differences in relevance of various portions of the content), contacts indicated in the communication, contacts of a user generating the communication, messaging windows associated with the communication, messaging applications associated with the communication, and/or social media applications associated with the communication. Relevance of information is used in various embodiments herein to determine rules for how the content may be extracted and/or analyzed for contextual information.

Relevance, as described herein, includes determining how closely related information is. The determination may be by comparison, and may use any criteria, such as thresholds and/or one or more key words. The information may be content within a communication, where a communication can contain one or more pieces (also referred to herein as portions, sections, or items) of content, and may include content that ranges from being not related at all (e.g., not relevant) to content that is directly related (e.g., highly relevant) to contacts indicated in the communication, contacts of a user generating the communication, messaging windows associated with the communication, messaging applications associated with the communication, and/or social media applications associated with the communication. Portions of content may also be referred to herein as simply “content.” There may be two levels of relevance (e.g., relevant and not relevant), or any number of levels of relevance. Any information may be compared to determine relevance. In various embodiments, user information may be used to determine relevance. The user information may include profile information, such as one or more user profiles, that is compared to content. Various types of relevance may be determined for one or more pieces of information, including relevance, priority, importance, precedence, weight, rank, etc. For example, relevance may determine how related content is to a user, contacts indicated in the communication, contacts of a user generating the communication, messaging windows associated with the communication, messaging applications associated with the communication, and/or social media applications associated with the communication, while priority ranks how important the content is. In various embodiments, priority may be based on how relevant a piece of content is. Any combination of one or more types of relevance may be configured and used. For example, content may have high relevance with a low priority and a low rank, content may have high relevance with a high importance and high rank, content may have low relevance with a high importance and a low priority, etc. Content may have any combinations of types of relevance.

As used herein, information includes communications, messages, electronic records (e.g., presence data), content, visual content including text and images, audio content, rich media, data, and/or data structures. Communications include emails, messages, documents, files, etc. Information includes content, and communications include content (also referred to herein as data). Content may be one type or multiple types (e.g., text, images, hyperlinks, etc.) and there may be multiple pieces of content within a communication or a piece of information, regardless of content type. Content may contain one or more variables. Communications may be data that is stored on a storage/memory device, and/or transmitted from one communication device to another communication device via a communication network.

Communications include messages and/or meeting invitations. A message and/or meeting invitation may be transmitted via one or more data packets. The formatting of such data packets may be based on the messaging protocol and/or communication protocol used for transmitting the data packets over the communication network.

Information related to communications may be referred to herein as communication information, communication data, or communication content, and variations of these terms. Communication information can include any type of data related to communications of a user and/or entity (e.g., information being sent to user(s), received from user(s), created by user(s), accessed by user(s), viewed by user(s), etc.). Content of a communication can include information associated with the communication as well as information contained within the communication. Content of a communication may include information not only that is sent and received, but also other information such as information that a user does not necessarily send or receive. Content of communications may be classified in various ways, such as by a timing of the content, items the content is related to, users the content is related to, key words or other data within fields of the communication (e.g., to field, from field, subject, body, etc.), among other ways of classifying the content. The content may be analyzed based on information associated with the content and/or variable(s), including the location of the content and/or variables as it relates to the communication (e.g., a field, sender, recipient, title, or body location within the communication).

As used herein, a data model may correspond to a data set that is usable in an artificial neural network and that has been trained by one or more data sets that describe communications between two or more entities. The data model may be stored as a model data file or any other data structure that is usable within a neural network or an artificial intelligence system.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Illustrative hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very large-scale integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Methods described or claimed herein can be performed with traditional executable instruction sets that are finite and operate on a fixed set of inputs to provide one or more defined outputs. Alternatively, or additionally, methods described or claimed herein can be performed using artificial intelligence, machine learning, neural networks, or the like. In other words, a system is contemplated to include finite instruction sets and/or artificial intelligence-based models/neural networks to perform some or all of the steps described herein.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method comprising:
identifying at least one user associated with a meeting invitation;
determining presence data associated with the at least one user;
providing at least a portion of the presence data to a machine learning network;
receiving an output from the machine learning network in response to the machine learning network processing at least the portion of the presence data, wherein the output comprises a predicted availability of the at least one user for each candidate temporal period of a set of candidate temporal periods; and
displaying one or more suggested temporal periods for the meeting invitation, from among the set of candidate temporal periods, based at least in part on the output from the machine learning network.

2. The method of claim 1, wherein:
determining the presence data comprises aggregating activity data associated with the at least one user over a temporal duration, from one or more data sources.

3. The method of claim 2, wherein the one or more data sources comprise:
a communication application;
an instant messaging application;
an application server associated with the communication application, the instant messaging application, or both;
a presence server associated with the communication application, the instant messaging application, or both;
a presence agent associated with the communication application, the instant messaging application, or both; or
a combination thereof.

4. The method of claim 1, further comprising:
identifying at least one scheduled calendar event associated with the at least one user and another meeting invitation, the at least one scheduled calendar event at least partially overlapping a candidate temporal period of the set of candidate temporal periods; and
providing the at least one scheduled calendar event to the machine learning network,
wherein receiving the output from the machine learning network occurs in response to the machine learning network processing temporal information associated with the at least one scheduled calendar event.

5. The method of claim 4, further comprising:
determining contextual information associated with the at least one scheduled calendar event; and
providing the contextual information to the machine learning network,
wherein receiving the output from the machine learning network occurs in response to the machine learning network processing the contextual information.

6. The method of claim 5, wherein the output from the machine learning network is based at least in part on a weighting factor associated with the contextual information.

7. The method of claim 5, wherein determining the contextual information comprises applying one or more language processing operations to content associated with the at least one scheduled calendar event.

8. The method of claim 1, further comprising:
determining time zone information associated with the at least one user; and
providing the time zone information to the machine learning network,
wherein receiving the output from the machine learning network occurs in response to the machine learning network processing the time zone information.

9. The method of claim 1, wherein the predicted availability comprises an active status, an inactive status, an offline status, or an intermittent active status of the at least one user.

10. The method of claim 1, wherein displaying the one or more suggested temporal periods comprises displaying, for the one or more suggested temporal periods:
the predicted availability of the at least one user;
scheduling information associated with the at least one user; or both.

11. The method of claim 1, further comprising;
selecting a temporal period from among the one or more suggested temporal periods, based at least in part on the output from the machine learning network; and
transmitting the meeting invitation to a device associated with the at least one user based at least in part on the selecting, the meeting invitation comprising an indication of the selected temporal period.

12. The method of claim 1, further comprising:
training the machine learning network based at least in part on training data, the training data comprising:
a temporal period selected by the at least one user, the machine learning network, or both in association with one or more other meeting invitations;
one or more previous outputs by the machine learning network; or
a combination thereof.

13. The method of claim 1, wherein the output from the machine learning network comprises, for each candidate temporal period of the set of candidate temporal periods, at least one of:
a probability score associated with the predicted availability of the at least one user; and
a confidence score associated with the probability score.

14. The method of claim 13, wherein displaying the one or more suggested temporal periods is based at least in part on the probability scores, the confidence scores, or both.

15. The method of claim 1, wherein the at least one user associated with the meeting invitation comprises at least one meeting host, at least one meeting invitee, or a combination thereof.

16. A device comprising:
a processor; and
a memory coupled with the processor, wherein the memory stores data that, when executed by the processor, enables the processor to:
identify at least one user associated with a meeting invitation;
determine presence data associated with the at least one user;
provide at least a portion of the presence data to a machine learning network;
receive an output from the machine learning network in response to the machine learning network processing at least the portion of the presence data, wherein the output comprises a predicted availability of the at least one user for each candidate temporal period of a set of candidate temporal periods; and
display one or more suggested temporal periods for the meeting invitation, from among the set of candidate temporal periods, based at least in part on the output from the machine learning network.

17. The device of claim 16, wherein determining the presence data comprises aggregating activity data associated with the at least one user over a temporal duration, from one or more data sources.

18. The device of claim 17, wherein the one or more data sources comprise:
a communication application;
an instant messaging application;
an application server associated with the communication application, the instant messaging application, or both;
a presence server associated with the communication application, the instant messaging application, or both;
a presence agent associated with the communication application, the instant messaging application, or both; or
a combination thereof.

19. The device of claim 17, wherein the data, when executed by the processor, further enables the processor to:
identify at least one scheduled calendar event associated with the at least one user and another meeting invitation, the at least one scheduled calendar event at least partially overlapping a candidate temporal period of the set of candidate temporal periods; and
provide the at least one scheduled calendar event to the machine learning network,
wherein receiving the output from the machine learning network occurs in response to the machine learning network processing temporal information associated with the at least one scheduled calendar event.

20. A system comprising:
a machine learning network;
a processor; and
a memory coupled with the processor, wherein the memory stores data that, when executed by the processor, enables the processor to:
identify at least one user associated with a meeting invitation;
determine presence data associated with the at least one user;
provide at least a portion of the presence data to the machine learning network;
receive an output from the machine learning network in response to the machine learning network processing at least the portion of the presence data, wherein the output comprises a predicted availability of the at least one user for each candidate temporal period of a set of candidate temporal periods; and
display one or more suggested temporal periods for the meeting invitation, from among the set of candidate temporal periods, based at least in part on the output from the machine learning network.
